(19) United States
(12) Patent Application Publication
(10) Pub. No.: US 2025/0323436 A1
(43) Pub. Date: Oct. 16, 2025

(54) HYBRID CONNECTOR

(71) Applicant: P-TWO INDUSTRIES INC., Taoyuan City (TW)

(72) Inventors: Chun-Wei Chang, Taoyuan City (TW); Jeng-Yi You, Taoyuan City (TW); Wang-Kun Tsai, Taoyuan City (TW)

(21) Appl. No.: 18/937,434

(22) Filed: Nov. 5, 2024

(30) Foreign Application Priority Data
Apr. 12, 2024 (TW) 113113677

(51) Int. Cl. H01R 12/71; H01R 12/70; H01R 13/11; H01R 13/24; H01R 13/50

(52) U.S. Cl. CPC H01R 12/716; H01R 12/707; H01R 13/113; H01R 13/2442; H01R 13/50

(57) ABSTRACT

A hybrid connector is disclosed, which comprises an insulating housing, a plurality of signal contacts, and a plurality of power source contacts. The signal contacts and the power source contacts are held by the insulating housing. The hybrid connector is mateable with a mating connector in a first direction. The insulating housing includes a plurality of signal fitting portions and a plurality of power fitting portions, the signal fitting portions and the power fitting portions being alternately arranged in a second direction perpendicular to the first direction, the signal contacts being disposed in the signal fitting portions, and the power source contacts being disposed in the power fitting portions. In this way, the power source contacts are dispersedly arranged, avoiding the concentration of power source contacts in a local area, and thus preventing heat from accumulating in the local area.

### CROSS-REFERENCES TO RELATED APPLICATIONS

This application claims the benefit of priority to Taiwanese Patent Application No. 113113677 filed on Apr. 12, 2024, which is hereby incorporated by reference in its entirety.

### BACKGROUND OF THE INVENTION

### Field of the Invention

The present invention relates to a hybrid connector, and in particular to a hybrid connector capable of transmitting both signals and electric power.

### Descriptions of the Related Art

It is known to use a hybrid floating connector having signal contacts and power source contacts for transmission of signals and electric power. Such a hybrid floating connector has been disclosed, for example, in CN113690663A. However, in the hybrid floating connector disclosed in CN113690663A, the power source contacts are concentrated at the two ends of the connector. Once the number of power source contacts is increased, a problem of high temperature due to heat accumulation at the two ends of the connector tends to occur.

### SUMMARY OF THE INVENTION

One object of the present invention is to provide a hybrid connector capable of preventing heat from accumulating in a local area of the connector by dispersedly arranging power source contacts.

According to one aspect of the present invention, a hybrid connector is provided, the hybrid connector comprising: an insulating housing, a plurality of signal contacts and a plurality of power source contacts, the plurality of signal contacts and the plurality of power source contacts being held by the insulating housing, the hybrid connector being mateable with a mating connector in a first direction, wherein the insulating housing comprises a plurality of signal-side fitting portions and a plurality of power-source-side fitting portions, the plurality of signal-side fitting portions and the plurality of power-source-side fitting portions are alternately arranged in a second direction perpendicular to the first direction, and a number of the plurality of signal-side fitting portions is one more than a number of the plurality of power-source-side fitting portions; and the plurality of signal contacts are arranged in the plurality of signal-side fitting portions, and the plurality of power source contacts are arranged in the plurality of power-source-side fitting portions.

According to the hybrid connector of the present invention, two of the plurality of signal-side fitting portions are arranged at two lateral ends of the hybrid connector respectively, and the plurality of power-source-side fitting portions are arranged in a middle area between the two lateral ends.

According to the hybrid connector of the present invention, the plurality of signal-side fitting portions include four signal-side fitting portions, the plurality of power-source-side fitting portions include three power-source-side fitting portions, and the four signal-side fitting portions and the three power-source-side fitting portions are arranged in the following order: the signal-side fitting portion, the power-source-side fitting portion, the signal-side fitting portion, the power-source-side fitting portion, the signal-side fitting portion, the power-source-side fitting portion and the signal-side fitting portion.

According to the hybrid connector of the present invention, the plurality of signal-side fitting portions include four signal-side fitting portions, the plurality of power-source-side fitting portions include three power-source-side fitting portions, the four signal-side fitting portions include two first signal-side fitting portions and two second signal-side fitting portions, and the two first signal-side fitting portions, the two second signal-side fitting portions and the three power-source-side fitting portions are arranged in the following order: the second signal-side fitting portion, the power-source-side fitting portion, the first signal-side fitting portion, the power-source-side fitting portion, the first signal-side fitting portion, the power-source-side fitting portion and the second signal-side fitting portion.

According to the hybrid connector of the present invention, a number of the signal contacts arranged in each first signal-side fitting portion is different from a number of the signal contact arranged in each second signal-side fitting portion.

According to the hybrid connector of the present invention, the number of the signal contacts arranged in each first signal-side fitting portion is greater than the number of the signal contact arranged in each second signal-side fitting portion.

According to the hybrid connector of the present invention, each power-source-side fitting portion includes two power source contact receiving slots each of which is provided for receiving one of the power source contacts.

According to the hybrid connector of the present invention, each power source contact includes a held portion, a soldered portion, a first contact arm and two second contact arms, the soldered portion is formed at a lower edge of the held portion, the first contact arm extends from an upper edge of the held portion, the two second contact arms extend from the upper edge of the held portion and located at two sides of the first contact arm respectively.

According to the hybrid connector of the present invention, the first contact arm is offset with respect to the held portion in a first offset direction, and the two second contact arms are offset with respect to the held portion in a second offset direction opposite to said first offset direction in such a manner that the first contact arm and the two second contact arms are capable of clamping a plate-like contact and of being placed in electric contact with said plate-like contact.

According to the hybrid connector of the present invention, each power source contact is plate-like.

The above and other objects and advantages of the present invention will become apparent from the accompanying drawings and the following detailed description.

### BRIEF DESCRIPTION OF THE DRAWINGS

FIG. 1 is a perspective view of a hybrid connector according to the first embodiment of the present invention.

FIG. 2 is an exploded perspective view of the hybrid connector according to the first embodiment of the present invention.

FIG. 3 is a sectional view of the hybrid connector according to the first embodiment of the present invention.

FIG. 4 is a perspective view of a power source contact of the hybrid connector according to the first embodiment of the present invention.

FIG. 5 is a perspective view of a signal contact of the hybrid connector according to the first embodiment of the present invention.

FIG. 6 is a perspective view of a hold down of the hybrid connector according to the first embodiment of the present invention.

FIG. 7 is a perspective view of a hybrid connector according to the second embodiment of the present invention.

FIG. 8 is an exploded perspective view of the hybrid connector according to the second embodiment of the present invention.

FIG. 9 is a perspective view of a power source contact of the hybrid connector according to the second embodiment of the present invention.

FIG. 10 is a perspective view of a signal contact of the hybrid connector according to the second embodiment of the present invention.

FIG. 11 is a perspective view of a hold down of the hybrid connector according to the second embodiment of the present invention.

### DETAILED DESCRIPTION OF THE PREFERRED EMBODIMENT

The hybrid connector according to the embodiment of the present invention will be described with reference to the drawings. In the drawings, the same components or components with similar functions are designated by the same reference numerals. The drawings are not necessarily drawn to scale.

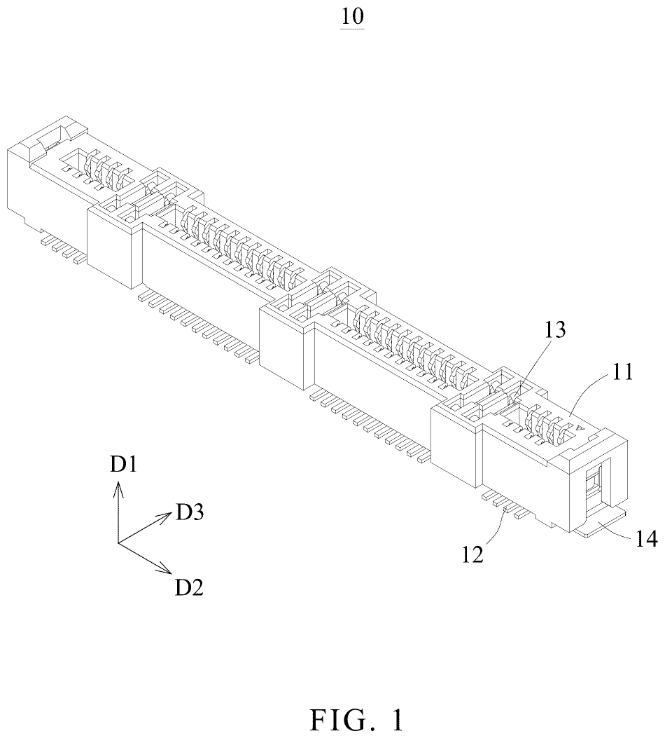

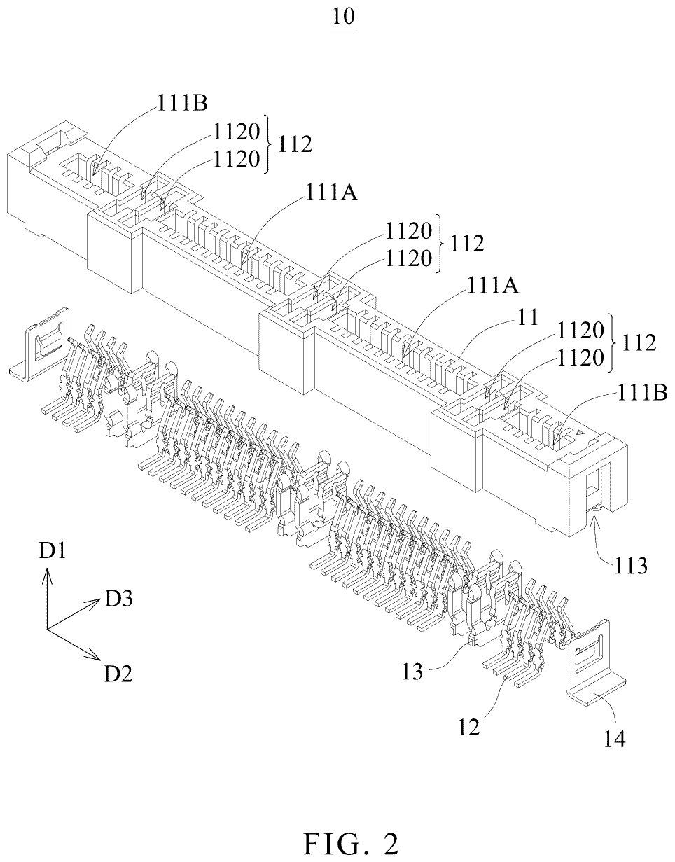

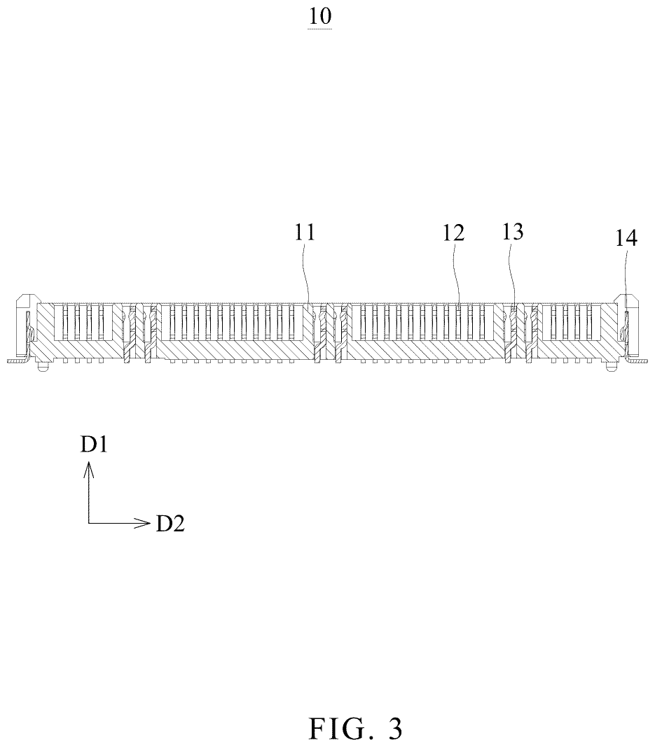

The hybrid connector according to the first embodiment of the present invention is described with reference to FIGS. 1, 2 and 3, wherein FIG. 1 is a perspective view of the hybrid connector according to the first embodiment of the present invention, FIG. 2 is an exploded perspective view of the hybrid connector according to the first embodiment of the present invention, and FIG. 3 is a sectional view of the hybrid connector according to the first embodiment of the present invention. The hybrid connector is generally designated by the reference numeral 10. The hybrid connector 10 is embodied as a board-mount receptacle connector. A mating connector (not shown) for the hybrid connector 10 is a board-mount plug connector. The hybrid connector 10 is mateable with the mating connector in a first direction D1.

The hybrid connector 10 includes an insulating housing 11, a plurality of signal contacts 12, a plurality of power source contacts 13 and two hold downs 14. The insulating housing 11 is made of an insulating synthetic resin or polymer material by injection molding. The insulating housing 11 includes a plurality of signal-side fitting portions (including first signal-side fitting portions 111A and second signal-side fitting portions 111B) and a plurality of power-source-side fitting portions 112. The signal-side fitting portions and the power-source-side fitting portions are alternately arranged in a second direction D2 perpendicular to the first direction D1. Each hold down 14 is inserted into a retaining slot 113 formed at an end of the insulating housing 11. By soldering the soldered portions of the hold downs 14 to the pads on the circuit board, the hybrid connector 10 can be firmly mounted to the circuit board.

Specifically, the insulating housing 11 includes two first signal-side fitting portions 111A, two second signal-side fitting portions 111B and three power-side fitting portions 112. The signal contacts 12 are arranged in two rows in the first signal-side fitting portions 111A and the second signal-side fitting portions 111B along the second direction D2. Each power-source-side fitting portion 112 includes two power source contact receiving slots 1120, each of which is provided for receiving one power source contact 13. The two first signal-side fitting portions 111A, the two second signal-side fitting portions 111B and the three power-source-side fitting portions 112 are arranged along the second direction D2 in the following order: the second signal-side fitting portion 111B, the power-source-side fitting portion 112, the first signal-side fitting portion 111A, the power-source-side fitting portion 112, the first signal-side fitting portion 111A, the power-source-side fitting portion 112 and the second signal-side fitting portion 111B. As a result, the second signal-side fitting portions 111B are respectively arranged at the two lateral ends of the hybrid connector, while the first signal-side fitting portions 111A and the power-source-side fitting portions 112 are arranged in the middle area between the two lateral ends.

In the first embodiment, 22 signal contacts 12 are arranged in each first signal-side fitting portion 111A, and 8 signal contacts are arranged in each second signal-side fitting portion 111B. However, the present invention is not limited thereto. The number of signal contacts arranged in the first signal-side fitting portion or the second signal-side fitting portion can be changed as needed. The number of signal contacts arranged in the first signal-side fitting portion may be the same as or different from the number of signal contacts arranged in the second signal-side fitting portion. The number of signal contacts arranged in the first signal-side fitting portion may be greater than the number of signal contacts arranged in the second signal fitting portion. According to the present invention, the number of signal-side fitting portions is one more than the number of power-source-side fitting portions. In this embodiment, the insulating housing 11 has four signal-side fitting portions and three power-source-side fitting portions.

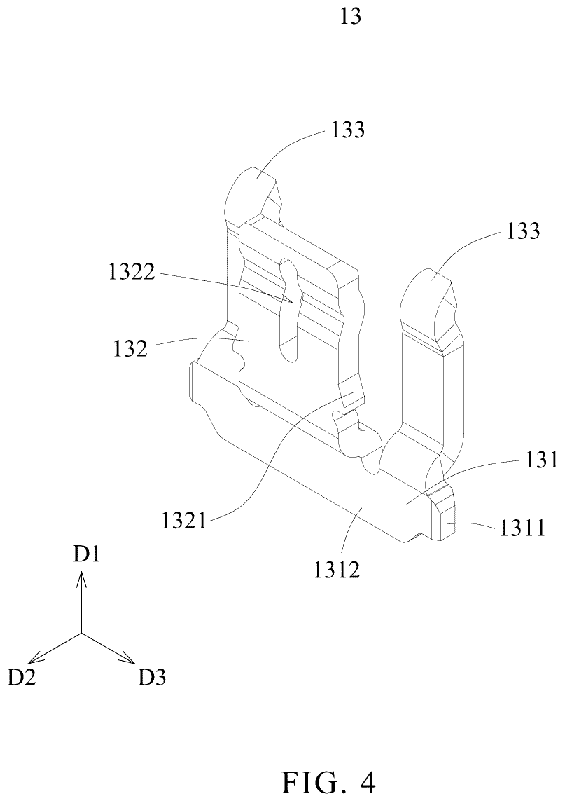

FIG. 4 is a perspective view of a power source contact 13 of the hybrid connector 10 according to the first embodiment of the present invention. The power source contact can be made of copper or a copper alloy. The power source contact 13 includes a held portion 131, a barb structure 1311 formed on two lateral edges of the held portion 131, a soldered portion 1312 formed on a lower edge of the held portion 131, a first contact arm 132 and two second contact arms 133. The first contact arm 132 and the two second contact arms 133 are formed on an upper edge of the held portion 131. The first contact arm 132 extends upward from the upper edge of the held portion 131. The two second contact arms 133 extend upward from the upper edge of the held portion and are respectively located at two sides of the first contact arm 132.

The first contact arm 132 is offset in a first offset direction with respect to the held portion 131, and the second contact arms 133 are offset in a second offset direction opposite to the first offset direction with respect to the held portion 131 in such a manner that the first contact arm 132 and the second contact arms 133 are capable of clamping a plate-like contact of the mating connector and being placed in electric contact with the plate-like contact. In order to further firmly hold the power source contact 13 in the power source contact receiving slot 1120, a barb structure 1321 is further formed on the lower portion of the first contact arm 132. The first contact arm 132 has a width wider than that of each second contact arm 133. Therefore, in order to increase the flexibility of the first contact arm 132, an elongated slit 1322 is further formed on the first contact arm 132 along the longitudinal direction of the first contact arm 132.

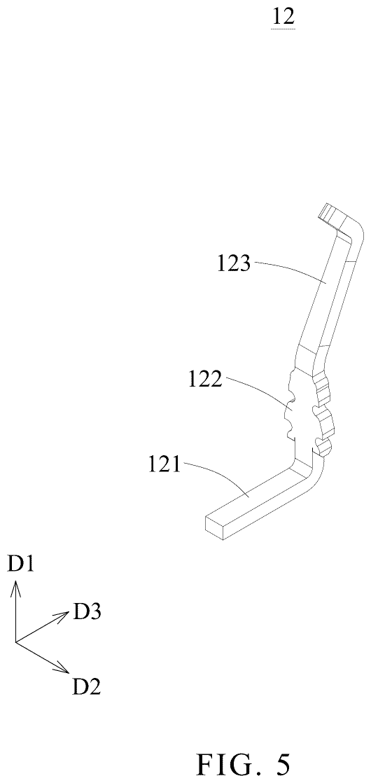

FIG. 5 is a perspective view of a signal contact 12 of the hybrid connector 10 according to the first embodiment of the present invention. The signal contact 12 can be made of copper or a copper alloy. The signal contact 12 includes a soldered portion 121, a held portion 122 extending from the soldered portion 121 and a contact arm 123 extending from the held portion 122. The soldered portion 121 extends in a third direction D3 perpendicular to both of the first direction D1 and the second direction D2. As shown in FIG. 1, the soldered portion 121 of the signal contact 12 extends out of the insulating housing 11, so that the soldered state of the soldered portion 121 can be observed when the hybrid connector 10 is mounted on a circuit board. The held portion 122 has a barb structure and is inserted into a signal contact holding hole formed in the insulating housing 11 in an interference fit manner. The contact arm 123 extends into the signal-side fitting portion. The distal end of the contact arm 123 is configured to be L-shaped or V-shaped.

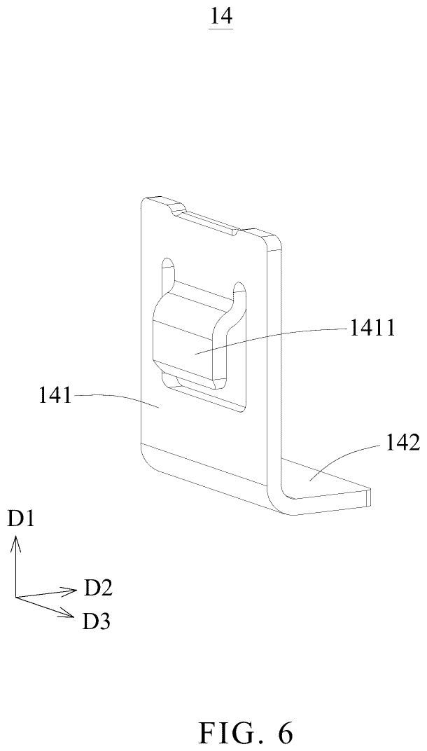

FIG. 6 is a perspective view of a hold down 14 of the hybrid connector 10 according to the first embodiment of the present invention. The hold down 14 can be made of a metal or alloy material (such as stainless steel). The hold down 14 has a body portion 141 and a soldered portion 142. A detent portion 1411 is formed on the body portion 141 by stamping. After the body portion 141 of the hold down 14 is inserted into the retaining slot 113 from the bottom of the insulating housing 11, the detent portion 1411 interferes with a step portion formed on the inner wall face of the retaining slot 113 (as can be seen in FIG. 3), preventing the body portion 141 of the hold down 14 from being detached from the retaining slot 113.

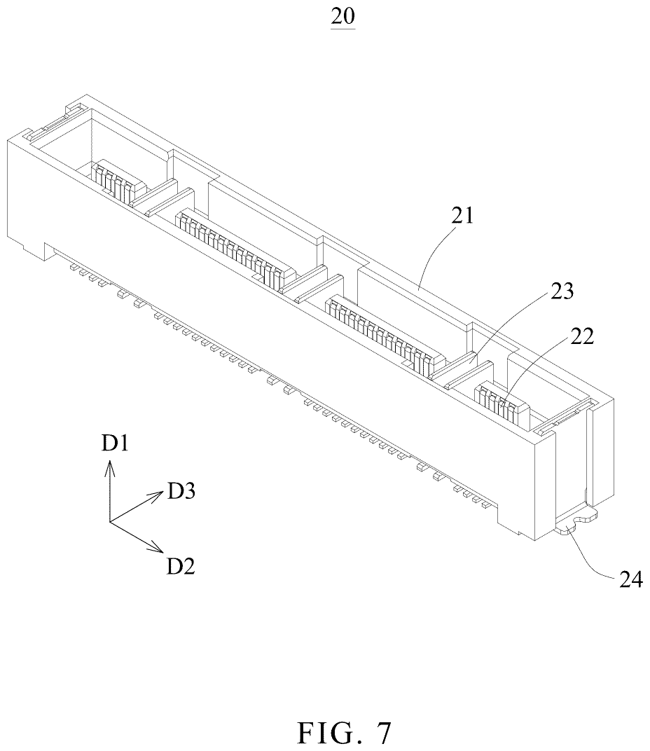

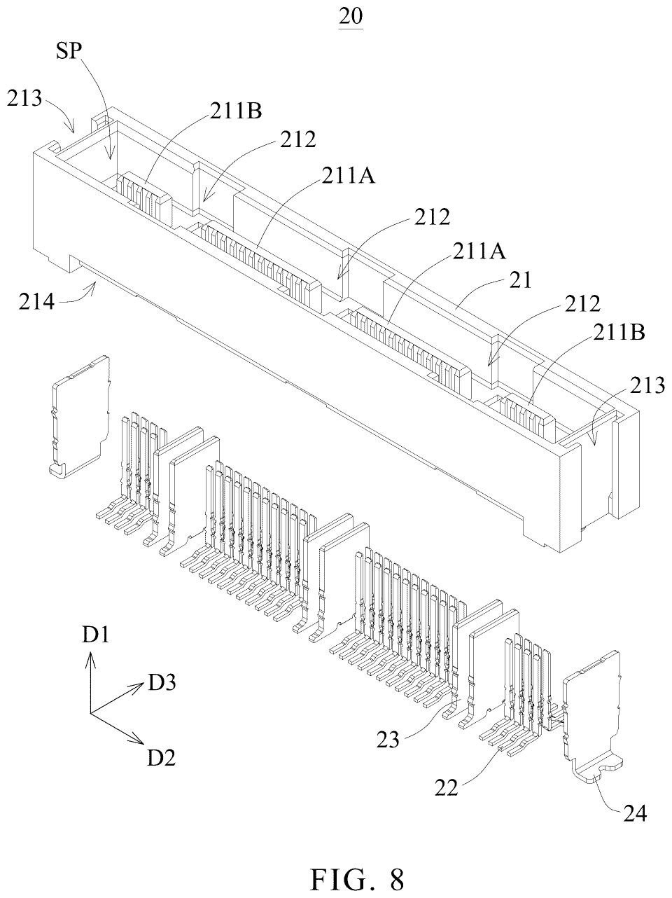

A hybrid connector according to a second embodiment of the present invention is described with reference to FIGS. 7 and 8, wherein FIG. 7 is a perspective view of the hybrid connector according to the second embodiment of the present invention, and FIG. 8 is an exploded perspective view of the hybrid connector according to the second embodiment of the present invention. The hybrid connector is generally designated by the reference numeral 20. The hybrid connector 20 is embodied as a board-mount plug connector and can serve as a mating connector for the hybrid connector 10 of the first embodiment. In other words, the hybrid connector 10 of the first embodiment and the hybrid connector 20 of the second embodiment is mateable with each other. Descriptions of the features that are the same or similar to those of the first embodiment in the second embodiment may be omitted.

The hybrid connector 20 includes an insulating housing 21, a plurality of signal contacts 22, a plurality of power source contacts 23 and two hold downs 24. The insulating housing 21 is made of an insulating synthetic resin or polymer material by injection molding. The insulating housing 21 has a receiving space SP which is opened upwardly. A plurality of signal-side fitting portions (211A, 211B) and a plurality of power-source-side fitting portions (212) are defined in the receiving space SP. The signal-side fitting portions and the power-source-side fitting portions are alternately arranged along the second direction D2. Each hold down 24 is inserted into a retaining slot 213 formed at the end of the insulating housing 21 in an interference fit manner. By soldering the soldered portions of the hold downs 24 to the pads on the circuit board, the second hybrid connector 20 can be firmly mounted to the circuit board.

Specifically, the insulating housing 21 includes two first signal-side fitting portions 211A, two second signal-side fitting portions 211B, and three power-source-side fitting portions 212. Each of the first signal-side fitting portions 211A and the second signal-side fitting portions 211B is in the form of a tongue. The area between adjacent signal fitting portions acts as a power-source-side fitting portion 212. As a result, the first signal-side fitting portions 211A, the second signal-side fitting portions 211B and the power-source-side fitting portions 212 are arranged along the second direction D2 in the following order: the second signal-side fitting portion 211B, the power-source-side fitting portion 212, the first signal-side fitting portion 211A, the power-source-side fitting portion 212, the first signal-side fitting portion 211A, the power-source-side fitting portion 212, and the second signal-side fitting portion 211B.

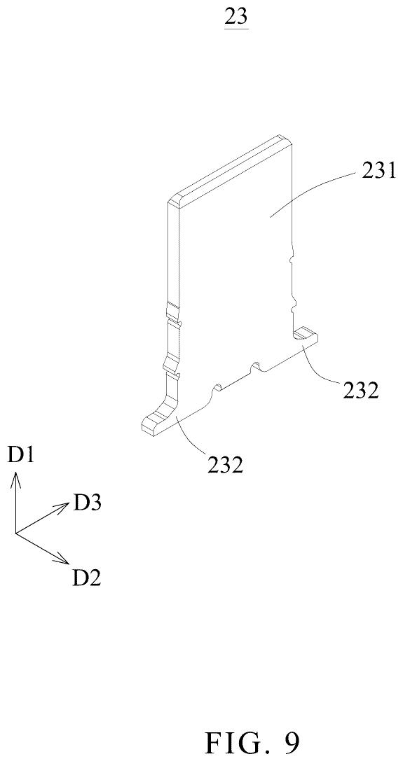

FIG. 9 is a perspective view of the power source contact 23 of the hybrid connector 20 according to the second embodiment of the present invention. The power source contact 23 can be made of copper or a copper alloy. The power source contact 23 includes a plate-shaped body portion 231 and two soldered portions 232 formed on the lower edge of the plate-shaped body portion 231. The soldered portions 232 extend in the third direction D3. The plate-shaped body portion 231 has a barb structure and is inserted into a power source contact holding hole formed in the insulating housing 21 in an interference fit manner. The power source contact holding hole is formed at the bottom of the receiving space SP. Two power source contact holding holes are formed in each power-source-side fitting portion 212.

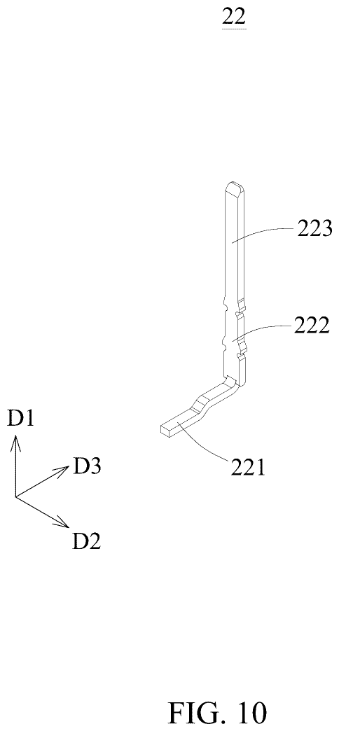

FIG. 10 is a perspective view of the signal contact 22 of the hybrid connector 20 according to the second embodiment of the present invention. The signal contact 22 can be made of copper or a copper alloy. The signal contact 22 includes a soldered portion 221, a held portion 222 extending from the soldered portion 221 and a contact portion 223 extending from the held portion 222. The soldered portion 221 extends in the third direction D3, and the held portion 222 and the contact portion 223 extend in the first direction D1. The held portion 222 has a barb structure and is inserted into a signal contact holding hole formed in the insulating housing 21 in an interference fit manner. The contact portions 223 of these signal contacts 22 are positioned on the two main surfaces of the tongues that act as signal-side fitting portions.

The outer surface of the sidewall of the insulating housing 21 of the hybrid connector 20 has a recessed portion 214 formed thereon. The recessed portion 214 is formed at the lower edge of the insulating housing 21. The formation of the recessed portion 214 makes it easy to inspect the soldered state of the soldered portions of the signal contacts or the power source contacts.

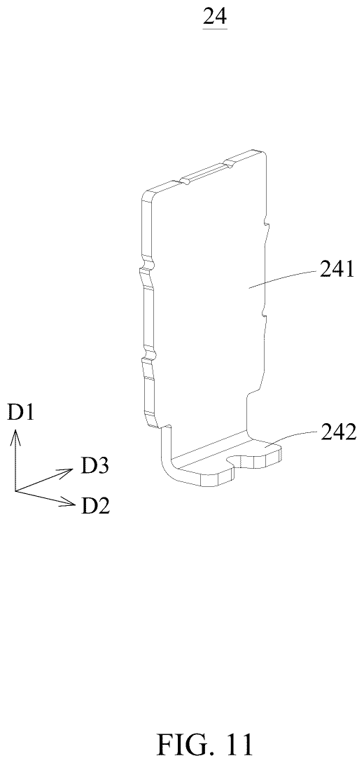

FIG. 11 is a perspective view of the hold down 24 of the hybrid connector 20 according to the second embodiment of the present invention. The hold down 24 can be made of a metal or alloy material (such as stainless steel). The hold down 24 has a plate-shaped body portion 241 and a soldered portion 242. The plate-shaped body portion 241 has a barb structure and is inserted into a retaining slot 213 formed in the insulating housing 21 in an interference fit manner.

Since the power source contacts are dispersedly arranged, concentration of the power source contacts in a local area can be avoided, and heat can be prevented from accumulating in the local area. Therefore, the hybrid connector according to the present invention is particularly advantageous in terms of heat dissipation.

If feasible, the technical features of the first embodiment can be applied to the second embodiment, or the technical features of the second embodiment can be applied to the first embodiment.

While this invention has been described in reference to preferred embodiments, it should be understood that numerous changes and modifications could be made within the spirit and scope of the inventive concepts described. Accordingly, it is intended that the invention not be limited to the disclosed embodiment, but that it have the full scope permitted by the language of the following claims.

What is claimed is:

1. A hybrid connector comprising: an insulating housing, a plurality of signal contacts and a plurality of power source contacts, the plurality of signal contacts and the plurality of power source contacts being held by the insulating housing, the hybrid connector being mateable with a mating connector in a first direction,
wherein the insulating housing comprises a plurality of signal-side fitting portions and a plurality of power-source-side fitting portions, the plurality of signal-side fitting portions and the plurality of power-source-side fitting portions are alternately arranged in a second direction perpendicular to the first direction, and a number of the plurality of signal-side fitting portions is one more than a number of the plurality of power-source-side fitting portions; and
the plurality of signal contacts are arranged in the plurality of signal-side fitting portions, and the plurality of power source contacts are arranged in the plurality of power-source-side fitting portions.

2. The hybrid connector of claim 1, wherein two of the plurality of signal-side fitting portions are arranged at two lateral ends of the hybrid connector respectively, and the plurality of power-source-side fitting portions are arranged in a middle area between the two lateral ends.

3. The hybrid connector of claim 1, wherein the plurality of signal-side fitting portions include four signal-side fitting portions, the plurality of power-source-side fitting portions include three power-source-side fitting portions, and the four signal-side fitting portions and the three power-source-side fitting portions are arranged in the following order: the signal-side fitting portion, the power-source-side fitting portion, the signal-side fitting portion, the power-source-side fitting portion, the signal-side fitting portion, the power-source-side fitting portion and the signal-side fitting portion.

4. The hybrid connector of claim 1, wherein the plurality of signal-side fitting portions include four signal-side fitting portions, the plurality of power-source-side fitting portions include three power-source-side fitting portions, the four signal-side fitting portions include two first signal-side fitting portions and two second signal-side fitting portions, and
the two first signal-side fitting portions, the two second signal-side fitting portions and the three power-source-side fitting portions are arranged in the following order: the second signal-side fitting portion, the power-source-side fitting portion, the first signal-side fitting portion, the power-source-side fitting portion, the first signal-side fitting portion, the power-source-side fitting portion and the second signal-side fitting portion.

5. The hybrid connector of claim 4, wherein a number of the signal contacts arranged in each first signal-side fitting portion is different from a number of the signal contact arranged in each second signal-side fitting portion.

6. The hybrid connector of claim 5, wherein the number of the signal contacts arranged in each first signal-side fitting portion is greater than the number of the signal contact arranged in each second signal-side fitting portion.

7. The hybrid connector of claim 1, wherein each power-source-side fitting portion includes two power source contact receiving slots each of which is provided for receiving one of the power source contacts.

8. The hybrid connector of claim 7, wherein each power source contact includes a held portion, a soldered portion, a first contact arm and two second contact arms, the soldered portion is formed at a lower edge of the held portion, the first contact arm extends from an upper edge of the held portion, the two second contact arms extend from the upper edge of the held portion and located at two sides of the first contact arm respectively.

9. The hybrid connector of claim 8, wherein the first contact arm is offset with respect to the held portion in a first offset direction, and the two second contact arms are offset with respect to the held portion in a second offset direction opposite to said first offset direction in such a manner that the first contact arm and the two second contact arms are capable of clamping a plate-like contact and of being placed in electric contact with said plate-like contact.

10. The hybrid connector of claim 1, wherein each power source contact is plate-like.
